(19) United States
(12) Patent Application Publication
(10) Pub. No.: US 2025/0166500 A1
(43) Pub. Date: May 22, 2025

(54) SENSING SYSTEM, SENSING METHOD AND COMPUTER READABLE MEDIUM

(71) Applicant: NEC Corporation, Minato-ku, Tokyo (JP)

(72) Inventors: Murtuza PETLADWALA, Tokyo (JP); Sakiko MISHIMA, Tokyo (JP); Takakiro KUMURA, Tokyo (JP)

(73) Assignee: NEC Corporation, Minato-ku, Tokyo (JP)

(21) Appl. No.: 18/832,673

(22) PCT Filed: Mar. 29, 2022
(86) PCT No.: PCT/JP2022/015585

§ 371 Date: Jul. 24, 2024

(51) Int. Cl. G08G 1/01; G08G 1/02

(52) U.S. Cl. CPC G08G 1/0133; G08G 1/0116; G08G 1/02

(57) ABSTRACT

An object of the present disclosure is to provide a sensing system, a sensing method and a non-transitory computer readable medium capable of localizing. A sensing system includes at least one memory configured to store instructions; and at least one processor configured to execute the instructions to: obtain time-distance information of an oscillation signal for each distributed sensing portion, while the oscillation signal is acquired by the plurality of distributed sensing portions for sensing a monitoring target and is induced by traffic of a moving object, estimate frequency densities of the oscillation signal sensed by the sensing portions based on the time-distance information, estimate degree of similarity between pair of the sensing portions based on the frequency densities, and localize a section of the monitoring target based on the degree of similarity.

### TECHNICAL FIELD

The present disclosure relates to a sensing system, a sensing method and a non-transitory computer readable medium.

### BACKGROUND ART

Monitoring system for infrastructures such as roads has been developed recently.

For example, Patent Literature 1 (PTL 1) discloses a traffic monitoring apparatus including a distributed acoustic sensor (DAS) for acquiring waterfall data and a processor connected to the DAS. The processor is further configured to pre-process the waterfall data, separate the pre-processed waterfall data into a plurality of patches, and process each of the plurality of patches to estimate at least one traffic flow property of the roadway.

### CITATION LIST

### Patent Literature

PTL 1: US 2021/0241615 A1

### SUMMARY OF INVENTION

### Technical Problem

If an infrastructure monitored by monitoring system includes not only usual roads but also bridges or other kind of irregular topography, the result of the monitoring may be distorted due to the irregular topography. Therefore, it is possible that localizing of sections in the infrastructure based on the monitoring result becomes inaccurate.

An object of the present disclosure is to provide a sensing system, a sensing method and a non-transitory computer readable medium capable of localizing.

### Solution to Problem

According to one aspect of the disclosure, there is provided a sensing system that includes: a dataset processing means for obtaining time-distance information of an oscillation signal for each distributed sensing portion, while the oscillation signal is acquired by the plurality of distributed sensing portions for sensing a monitoring target and is induced by traffic of a moving object; a frequency density estimating means for estimating frequency densities of the oscillation signal sensed by the sensing portions based on the time-distance information; a similarity estimating means for estimating degree of similarity between pair of the sensing portions based on the frequency densities; and a localization means for localizing a section of the monitoring target based on the degree of similarity.

According to one aspect of the disclosure, there is provided a sensing method that includes: obtaining time-distance information of an oscillation signal for each distributed sensing portion, while the oscillation signal is acquired by the plurality of distributed sensing portions for sensing a monitoring target and is induced by traffic of a moving object; estimating frequency densities of the oscillation signal sensed by sensing portions based on the time-distance information; estimating degree of similarity between pair of the sensing portions based on the frequency densities; and localizing a section of the monitoring target based on the degree of similarity.

According to one aspect of the disclosure, there is provided a non-transitory computer readable medium storing a program for causing a computer to execute: obtaining time-distance information of an oscillation signal for each distributed sensing portion, while the oscillation signal is acquired by the plurality of distributed sensing portions for sensing a monitoring target and is induced by traffic of a moving object; estimating frequency densities of the oscillation signal sensed by sensing portions based on the time-distance information; estimating degree of similarity between pair of the sensing portions based on the frequency densities; and localizing a section of the monitoring target based on the degree of similarity.

### Advantageous Effects of Invention

According to the present disclosure, it is possible to provide a sensing system, a sensing method and a non-transitory computer readable medium capable of localizing.

### BRIEF DESCRIPTION OF DRAWINGS

FIG. 1 is an example of a block diagram of a sensing system according to a first example embodiment.

FIG. 2 is an example of a flowchart illustrating a method of the sensing system according to the first example embodiment.

FIG. 3A illustrates an example of a wide area localization system that includes an optical fiber cable according to a second example embodiment.

FIG. 3B illustrates an example of schematic illustration of a view of a road with the optical fiber cable.

FIG. 4 is an example of a block diagram of a sensing server according to a second example embodiment.

FIG. 5A illustrates one example of time-distance charts at each of the sequential sensing points on the optical fiber cable attached to the road.

FIG. 5B illustrates one example of power spectral densities.

FIG. 5C illustrates one example of a cross-correlation matrix obtained for each of the frequency responses of each of the sensing points.

FIG. 6 illustrates an example of data processed in the sensing server 100.

FIG. 7 is an example of a flowchart illustrating a method of the sensing system according to the second example embodiment.

FIG. 8A illustrates one example of the number of events occurring at each frequency at a bridge section.

FIG. 8B illustrates one example of the shift of frequency distribution corresponding to FIG. 8A.

FIG. 9 is a block diagram of a computer apparatus according to embodiments.

### DESCRIPTION OF EMBODIMENTS

Example embodiments according to the present disclosure will be described hereinafter with reference to the drawings. Note that the following description and the drawings are omitted and simplified as appropriate for clarifying the explanation. Further, the same elements are denoted by the same reference numerals (or symbols) throughout the drawings, and redundant descriptions thereof are omitted as required. Also, in this disclosure, unless otherwise specified, “at least one of A or B (A/B)” may mean any one of A or B, or both A and B. Similarly, when “at least one” is used for three or more elements, it can mean any one of these elements, or any plurality of elements (including all elements). Further, it should be noted that in the description of this disclosure, elements described using the singular forms such as “a”, “an”, “the” and “one” may be multiple elements unless explicitly stated.

### First Example Embodiment

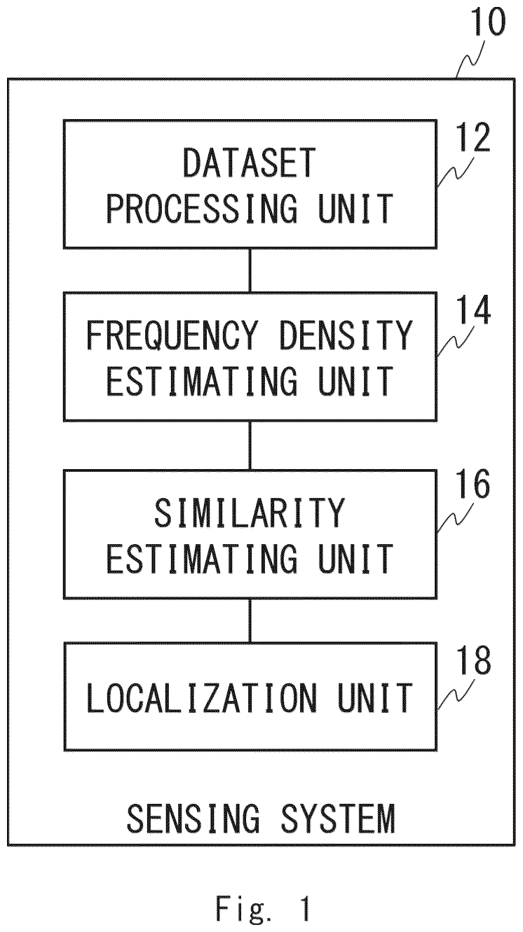

First, a sensing system 10 according to a first example embodiment of the present disclosure is explained with reference to FIG. 1.

Referring to FIG. 1, the sensing system 10 includes a dataset processing unit 12, a frequency density estimating unit 14, a similarity estimating unit 16 and a localization unit 18. The sensing system 10 may be one or more computers and/or machines. As an example, at least one of components in the sensing system 10 can be installed in a computer as a combination of one or a plurality of memories and one or a plurality of processors. The computer(s) used as the sensing system 10 may be a server.

The dataset processing unit 12 obtains time-distance information of oscillation signals for each distributed sensing portion. The oscillation signals are time-series signals which are acquired by the plurality of distributed sensing portions for sensing a monitoring target and are induced by traffic of a moving object (target object). The distributed sensing portions may be multiple, spaced apart points on a long linear sensor (e.g., optical fiber cable), a plurality of independent sensors and so on. The distributed sensing portions are laid along the way through which the moving object passes. The moving object may be a variety of objects moving on land-for example, motor vehicles (including cars, motorcycles, buses, tracks or the like), trains, trams, bicycles, vehicles that are not moved by machines, pedestrians (walking persons) or the like, and the ways the moving object passes may be roads (including highways and ordinary roads), railroads, bridges, pedestrian or bicycle paths or the like. The time-distance information indicates time and location of the oscillation, and for example, it may be expressed as time-distance graph information. The time-distance graph information maybe also referred to as waterfall dataset in the disclosure.

Any known technologies can be applied to the processing of the dataset processing unit 12. For example, the sensing system 10 may obtain the raw dataset (oscillation signal) measured by the plurality of distributed sensing portions and pre-process the raw dataset into the time-distance information. However, the dataset processing unit 12 may acquire the time-distance information generated by another apparatus.

The frequency density estimating unit 14 estimates frequency densities of the oscillation signal sensed by the sensing portions based on the time-distance information. The frequency density may be called as a spectral density, and it shows density distribution at all frequencies.

The similarity estimating unit 16 estimates degree of similarity between pair of the sensing portions based on the frequency densities. For example, the degree of similarity may be calculated using the peaks or graphs of the frequency densities of the pair of sensing portions. The degree of similarity is one feature of the monitoring target and implies difference in the physical properties of the different sections of the monitoring target.

The localization unit 18 localizes a section of the monitoring target based on the degree of similarity. For example, the localization unit 18 may locate a section having different physical properties compared to the rest of the monitoring target.

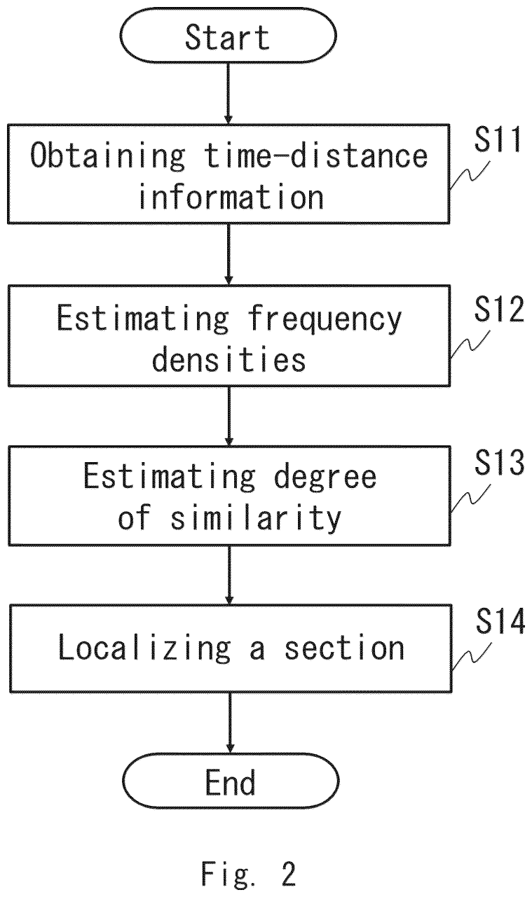

Next, referring to the flowchart in FIG. 2, an example of the operation of the present example embodiment will be described. The detail of each processing in FIG. 2 is already explained above.

First, the dataset processing unit 12 obtains time-distance information of an oscillation signal for each distributed sensing portion (step S11). Next, the frequency density estimating unit 14 estimates frequency densities of the oscillation signal sensed by the sensing portions based on the time-distance information obtained by the dataset processing unit 12 (step S12).

The similarity estimating unit 16 estimates degree of similarity between pair of the sensing portions based on the frequency densities estimated by the frequency density estimating unit (step S13). Then, the localization unit 18 localizes a section of the monitoring target based on the degree of similarity estimated by the similarity estimating unit 16 (step S14).

As the sensing system 10 estimates the degree of similarity between pair of the sensing portions based on the frequency densities, it can grasp the difference in the physical properties within the monitoring target, such as road and other kind of infrastructures. Therefore, by using the data of the similarity, the sensing system 10 can localize a section of the monitoring target considering the difference in the physical properties within the monitoring target. For example, the sensing system 10 can localize a bridge section of a road.

### Second Example Embodiment

A second example embodiment of this disclosure will be described below referring to the accompanied drawings. This second example embodiment explains one of the specific examples of the first example embodiment, however, specific examples of the first example embodiment are not limited to this example embodiment.

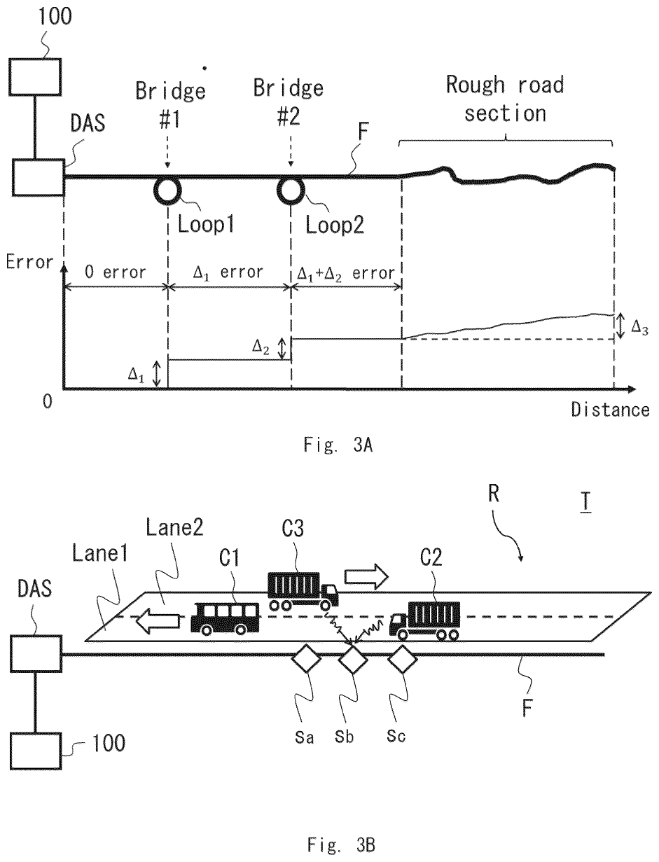

FIG. 3A illustrates an example of a wide area localization system T that includes an optical fiber cable F (sensing optical fiber), a Distributed Acoustic Sensor (DAS: it functions as a sensing device) and a sensing server 100. In FIG. 3A, the optical fiber cable F buried in the ground is laid along a road R, especially along a target lane. The optical fiber cable F is placed in order to measure response oscillation of the road R due to moving objects on the road such as vehicles. The road has two bridges and a rough road section, and there is one loop of the optical fiber cable F at each of the two bridges.

FIG. 3A also illustrates degree of error in result of monitoring induced by the features of the road. Specifically, errors of Δ1 and Δ2 are caused by the loops 1 and 2, and an error of Δ3 is caused by the rough road section. Δ1 and Δ2 correspond to the lengths of the loops 1 and 2 respectively, and Δ3 corresponds to the length and the degree of unevenness in the rough road section. Errors increase more with distance from a location of the DAS due to these obstacles. However, the sensing server 100 can localize road sections to sequential sensing points (sensing portions) of the optical fiber cable as shown below.

FIG. 3B illustrates an example of schematic illustration of a view of the road R with the optical fiber cable F. In FIG. 3B, the optical fiber cable F is installed under and along surface of the road R and used for measuring response oscillation of the road R due to vehicles C1 to C3, which are moving objects and are passing along the optical fiber cable F. Further, the optical fiber cable F includes a plurality of sensing portions, such as sₐ to s_{c}. Each of sensing portions in the optical fiber cable F will be referred to as a sensor.

In FIG. 3B, the vehicles C1 and C2 in the lane 1 are passing the road R from the right side to the left side, and the vehicle C3 in the lane 2 is moving in the opposite direction of the vehicles C1 and C2. The sensing server 100 monitors the road R and can detect each traffic event of the vehicles.

An oscillation signal (for example, acoustics or vibration data) is induced in the optical fiber cable F by the vehicles (especially by axles of the vehicles passing on the road R with the optical fiber cable). That is, the oscillation signal represents oscillation on the road R. For example, in FIG. 3B, the sensor s_{b} detect oscillation signal from the vehicle C2 and C3 at an instant of time.

The DAS detects the oscillation signal at each of the plurality of sensor of the optical fiber cable F. The DAS is able to detect the oscillation signal of the road R induced by axles of a vehicle, when the vehicle is passing on any traffic lane of the road R. The oscillation signals can be measured at any location on the optical fiber cable F. For example, when the sensing range is 50 km and the spatial resolution is 4 m, the oscillation signal at 12500 points (sensing channels) could be measured. The DAS transmits the oscillation signal in digital data via wired communication to the sensing server 100. However, the communication between the DAS and the sensing server 100 can be done by wireless communication.

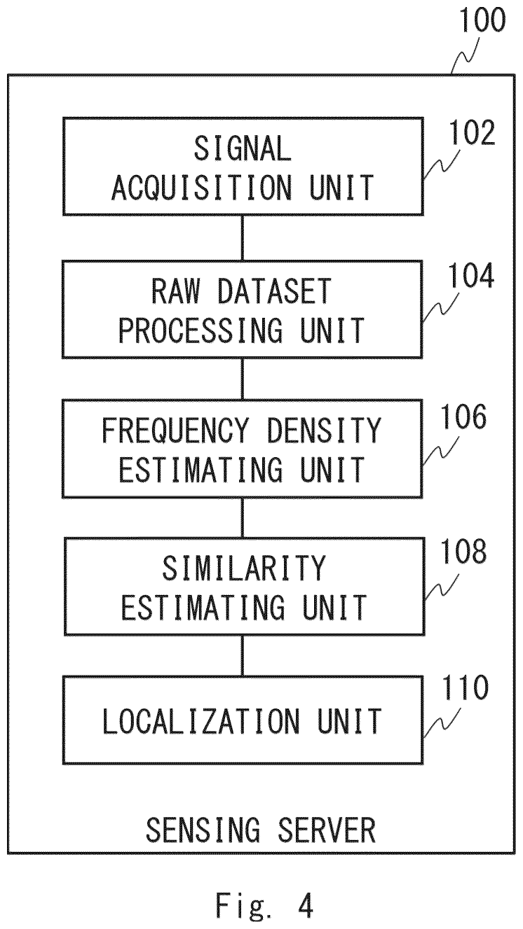

FIG. 4 is a block diagram of the sensing server 100, an example of the sensing server. Referring to FIG. 4, the sensing server 100 includes a signal acquisition unit 102, a raw dataset processing unit 104, a frequency density estimating unit 106, a similarity estimating unit 108 and a localization unit 110. The sensing server 100 is one specific example of the sensing system 10 and it may include other units for computation. Each unit of the sensing system 10 will be explained in detail.

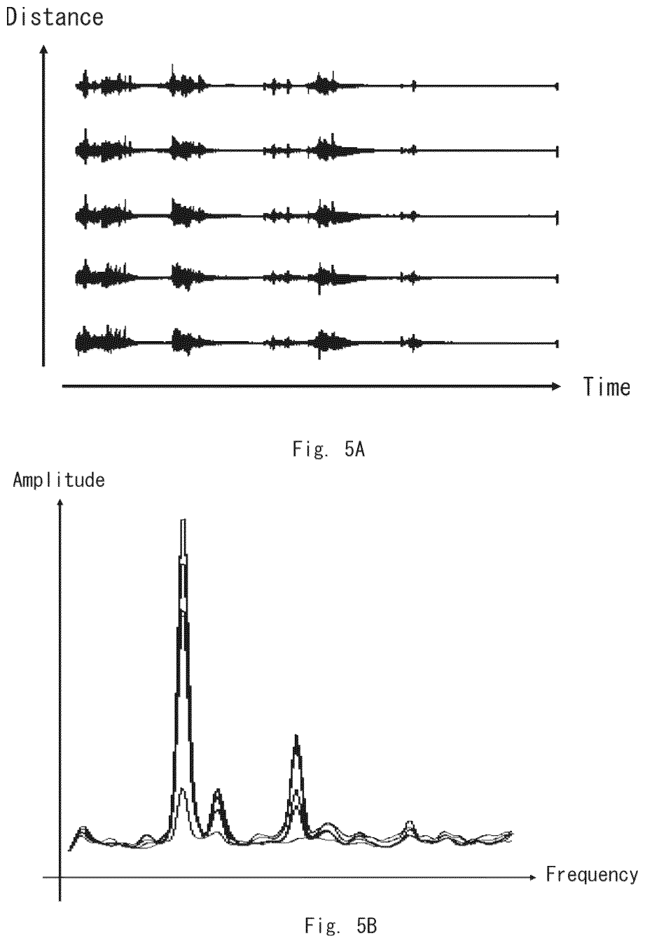

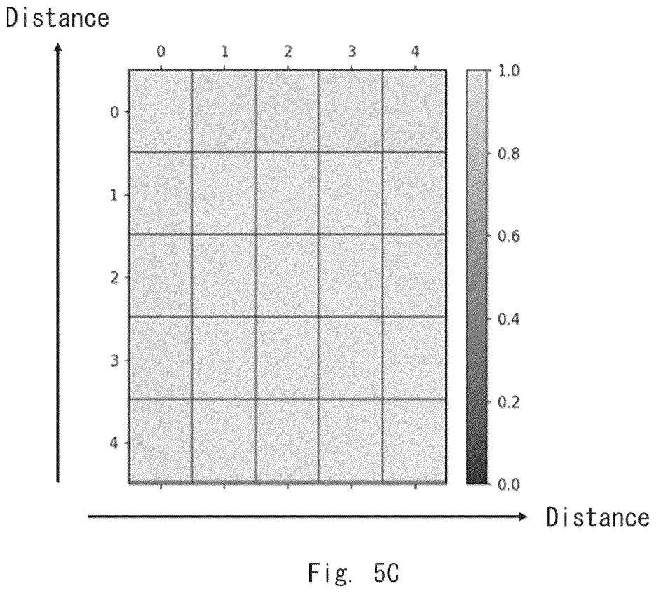

The signal acquisition unit 102 functions as an interface of the sensing server 100 and acquires the raw oscillation signal data (hereinafter also referred to raw dataset: X_{raw}) from a DAS interrogator. Especially, the signal acquisition unit 102 acquires the raw signal data at each of the sequential sensing points of the optical fiber cable F. FIG. 5A illustrates one example of time-distance charts of the X_{raw} at each of the sequential sensing points on the optical fiber cable attached to the road R.

The signal acquisition unit 102 outputs the X_{raw} to the raw dataset processing unit 104. Furthermore, the signal acquisition unit 102 may preprocess the X_{raw}, if necessary. For example, the signal acquisition unit 102 may filter the X_{raw} and output the filtered X_{raw}.

The raw dataset processing unit 104 obtains the X_{raw} output by the signal acquisition unit 102 for each of the sequential sensing points. Next, the raw dataset processing unit 104 removes an amplitude offset from the X_{raw} and standardizes signal amplitude of the X_{raw}. The removed amplitude offset is a DC (Direct Current) component of the measured signal in each of the sensing points, which is possibly caused by a phase drift in the interrogator of the DAS. The standardization is done to normalize standard deviation of each channel to a unity.

Then, the raw dataset processing unit 104 uses the standardized signal to calculate a time-distance matrix of the X_{raw} for each of the sequential sensing points of the optical fiber cable F. The raw dataset processing unit 104 may generate waterfall traces of oscillation intensities by applying sum of absolute intensities to a window of a predetermined length.

The frequency density estimating unit 106 uses the time-distance matrix (generated by the raw dataset processing unit 104) to estimate power spectral densities (frequency densities) of each of the oscillation signals obtained at every sensing point of the optical fiber cable F. Specifically, the frequency density estimating unit 106 may apply Fast Fourier Transform (FFT) to each column of each time-distance matrix and uses power spectral densities-based techniques in order to estimate the power spectral densities as dominating structural features. Further, the frequency density estimating unit 106 may obtain the FFT-based feature vectors from each column of each time-distance matrix, which are obtained by the raw dataset processing unit 104. As a result, the frequency density estimating unit 106 can obtain distribution of FFT coefficients for estimating the power spectral densities. The frequency density estimating unit 106 may standardize the FFT coefficients to obtain the frequency densities.

The frequency density represents the distribution of the frequency in the given oscillation signal and shows a peak frequency of each sensing point. Thus, it is useful to obtain the relationship between different structural frequencies, for example, bridge and a nearby road ground section.

FIG. 5B illustrates one example of the power spectral densities. In another words, FIG. 5B illustrates the frequency domain responses obtained from each sensing point of the optical fiber cable F. For example, the frequency response at each sensing point on the road infrastructure shows oscillation at a natural resonance frequency. The peak resonance frequencies (peak frequencies) may be used as structural features to identify sections on the infrastructure.

Referring back to FIG. 4, the similarity estimating unit 108 selects sequential sensing points from the time-distance matrices and obtains cross-correlation matrices calculated from the peak frequencies (frequency densities) of each sequential sensing points. The sequential sensing points may be referred as a section within the range of section length L.

Specifically, the similarity estimating unit 108 uses the frequency densities generated by the frequency density estimating unit 106 to estimate similarity scores between each pair of sequential sensing points near to pre-defined length of sequential sensing points. The similarity score is calculated by the cross-correlation matrix and it means a correlation coefficient between two frequency densities of the two signal of the two sensing points. The similarity estimating unit 108 also may use threshold parameters within a range of similarity scores to select high similar frequency densities of the sections. Namely, the high similar frequency densities have similarity scores (indices) exceed a given threshold. As an alternative example, the similarity estimating unit 108 may obtain the highest similarity index between frequency densities of the sequential sensing points within the range of similarity scores, wherein the sequential sensing points forms one section with the length L. Consequently, the similarity estimating unit 108 can select the sequential sensing points (channels) with high similarity indices to localize locations of the road.

FIG. 5C illustrates one example of the cross-correlation matrix obtained for each of the frequency responses of each of the sensing points within a pre-determined frequency range of interest corresponding to each structural section. For example, bridge frequencies less than 5 Hz are used to obtain cross-correlation to differentiate the bridge and other nearby sections of the bridge. The high (e.g., the highest) index similarity between nearby sensing points represents the frequency responses that match with each other of a particular section on the road infrastructure. In FIG. 5C, the vertical and horizontal sides of the matrix indicate the distance from a given sensing point.

The localization unit 110 determines locations of each of the section corresponding to the sensing portion with the high similarity index (e.g., the highest similarity index) exceeding the given threshold. The located section is useful to localize the identified sections to sections of layout of the optical fiber cable F attached to the road infrastructure. The fiber layout may be a map of fiber attachments that corresponds to a physical position at each of the road sections with a particular physical distance. The fiber layout map may be used to localize the optical fiber cable sensing channel identified by the processes show above to road sections. Consequently, the localization unit 110 can use the map information to localize real location of the sections of the wide area infrastructure, such as the road infrastructure with a bridge or tunnel, and to monitor traffic and infrastructure properties.

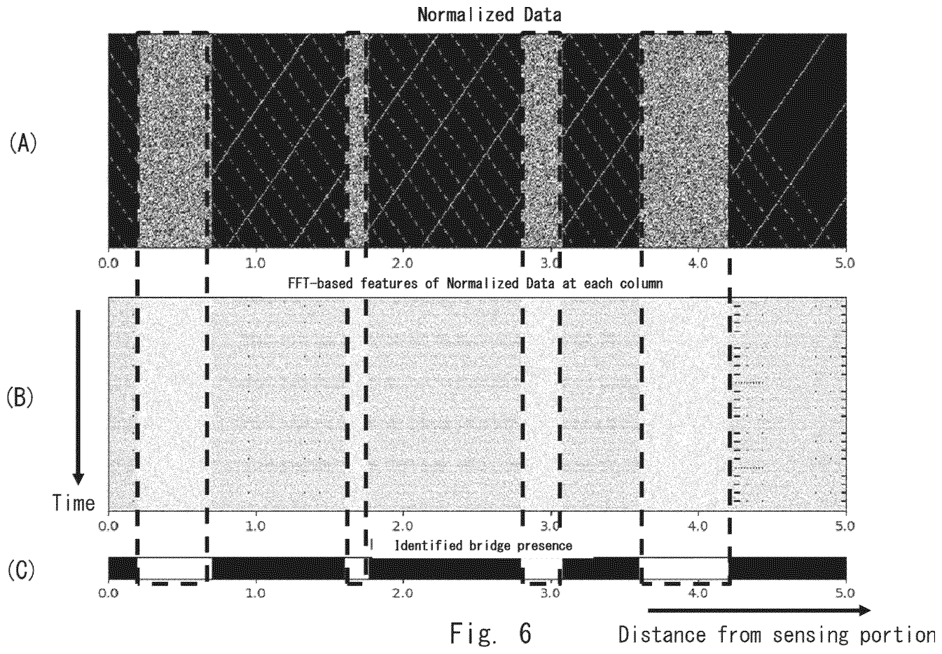

FIG. 6 illustrates an example of data processed in the sensing server 100. FIG. 6 (A) shows an example snap of the normalized waterfall dataset (time-distance graph) in the situation vehicles are going away and coming towards the sensing server 100 and oscillation intensities of the optical fiber cable F (the oscillation signals) are visible; each line in FIG. 6 (A) shows each trajectory of the vehicle. The oscillation intensities are proportional to type of vehicle passing on the road.

Further, in FIG. 6 (A), dashed boxes represent bridge sections present on the roadway, where the vibration intensities are unclear due to high vibrations of the bridge sections. The raw dataset processing unit 104 can obtain the time-distance information shown in FIG. 6 (A).

FIG. 6 (B) shows an example snap of the FFT-based features of normalized data shown in FIG. 6 (A) at each column of each of the time-distance graph matrices. In FIG. 6 (B), dashed boxes represent the bridge sections present on the roadway corresponding to the dashed boxes in FIG. 6 (A). The frequency density estimating unit 106 can obtain the FFT-based features shown in FIG. 6 (B) by using the time-distance matrix.

FIG. 6 (C) shows an example snap of the identified bridge presence corresponding to the FFT-based features shown in FIG. 6 (B). In FIG. 6 (C), dashed boxes represent the bridge sections present on the roadway corresponding to the dashed boxes in FIGS. 6 (A) and 6 (B). The localization unit 110 determines locations of each of the section with the high similarity indices to localize (identify) the bridge sections shown in FIG. 6 (C).

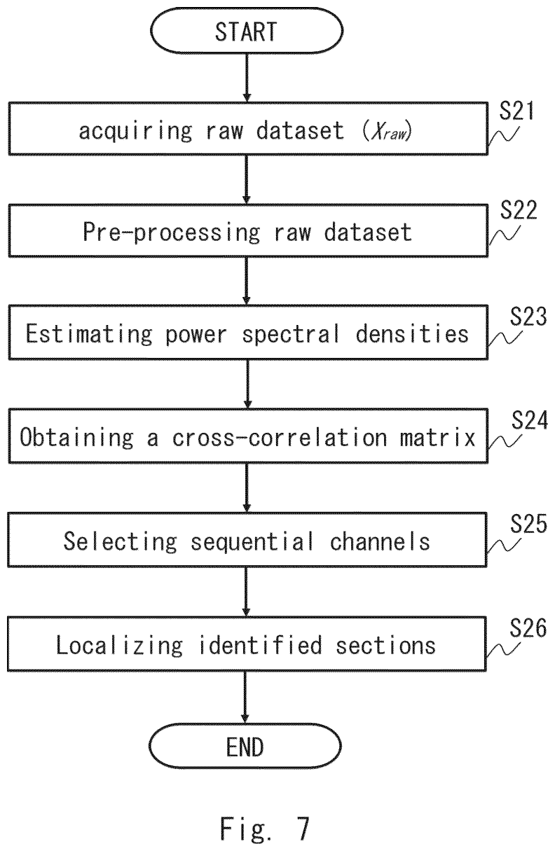

Next, referring to the flowchart in FIG. 7, an example of the operation of the sensing server 100 will be described. The detail of each processing in FIG. 7 is already explained.

First, the signal acquisition unit 102 acquires the raw dataset (X_{raw}) and output it to the raw dataset processing unit 104 (step S21). Next, the raw dataset processing unit 104 pre-processes the X_{raw} (step S22). To be specific, the raw dataset processing unit 104 removes an amplitude offset from the X_{raw} and standardizes signal amplitude of the X_{raw}. After that, the raw dataset processing unit 104 uses the standardized signal to calculate a time-distance matrix of the X_{raw} for each of the sequential sensing points of the optical fiber cable F.

Then, the frequency density estimating unit 106 estimates power spectral densities of each of the oscillation signals obtained at every sensing point of the optical fiber cable F (step S23). Especially, the frequency density estimating unit 106 can obtain distribution of FFT coefficients for estimating the power spectral densities.

Next, the similarity estimating unit 108 selects sequential sensing points from the time-distance matrices and obtains cross-correlation matrices calculated from the peak frequencies of each sensing points (step S24). Then, the similarity estimating unit 108 selects the sequential sensing points (channels) with high similarity indices to localize locations of the road (step S25).

Finally, the localization unit 110 localize the identified sections with the sections of layout of the optical fiber cable F (step S26).

In related art, an optical fiber cable acquires oscillation signal (acoustics or vibration data), wherein the optical fiber cable is attached to a monitoring target such as road infrastructures. A sensing device acquires the environment oscillation around a target to be monitored by analysing a Rayleigh backscattered light of a pulse light, which is transmitted in the optical fiber cable.

The length of the optical fiber cable laid along the road is longer than the real physical length of the road. The sensing application that utilizes the embedded optical fiber cable may require calibration of sensing points with a target object in order to ensure that the sensing point on the optical fiber cable is near to the target object (e.g., bridge, tunnel and/or road structure).

Visible and non-visible trajectory sections of the optical fiber cable are used to classify bridge sections on the road and localize the points on the optical fiber cable. On the other hand, localizing the points on the fiber cable is difficult if there are only either visible or non-visible trajectory sections. For example, if time-distance waterfall graph of the oscillation signal has only visible trajectory sections, it would be difficult to localize the reference points and overall difficult to localize the road infrastructure.

In this disclosure, the sensing server 100 can estimate the degree of similarity between pair of the sensing portions based on the frequency densities and localize a section of the monitoring target based on the degree of similarity. Therefore, the sensing server 100 can localize exact sections of the road infrastructures.

Further, the raw dataset processing unit 104 may generate a time-distance matrix of the oscillation signal as the time-distance information by removing a bias component from the oscillation signal and standardizing amplitudes of the oscillation signal. Therefore, the sensing server 100 can calculate the degree of similarity with simple preparations and reduce processes to be required for the localizing.

Further, the frequency density estimating unit 106 may estimate the frequency densities of the oscillation signal of the sensing portions by applying Fast Fourier Transformation (FFT) to columns of the time-distance matrix. Therefore, the sensing server 100 can calculate the degree of similarity with the known technique and the calculation method is easy to implement.

Further, the similarity estimating unit 108 may calculate a cross-correlation matrix between the frequency densities of the sensing portions to estimate the degree of similarity. Therefore, the sensing server 100 can calculate the degree of similarity with simple preparations and reduce processes to be required for the localizing.

Further, the localization unit 110 may localize the section corresponding to the sensing portions with a similarity index exceeding a given threshold. Therefore, the sensing server 100 can identify sections more precisely, wherein the sections may have different physical properties compared to the rest of the monitoring target.

Further, the localization unit 110 may use map information to localize real location of the section. Therefore, the sensing server 100 can identify sections more precisely by referencing the real map information.

Further, the wide area localization system T may comprise an optical fiber cable F which includes the sensing portions and is attached to a road. Therefore, the sensing method disclosed in the second embodiment can be applied to monitoring road infrastructures. For example, the sensing server 100 can monitors a bridge section in road infrastructure, where natural frequencies of bridge maybe monitored by analyzing a statistical distribution of several events of vehicle passage over the bridge section. The statistical distribution is mean and standard deviation of frequencies and can be generated by the frequency density estimating unit 106 based on the spectral densities of the sequential sensing points. The shift or variation of frequency distribution maybe used as an index of change in structure properties likely to be infrastructure damages. The sensing server 100 can obtain the statistical distribution (natural frequencies) and analyze them to estimate natural frequencies and eventually the change in structure properties at a particular section by using the real location information of the section of the optical fiber cable F localized by the localization unit 110. The particular section is, for example, a bridge or tunnel section, but not limited to this. In this way, the sensing server 100 can detect the degree of damage at the particular section.

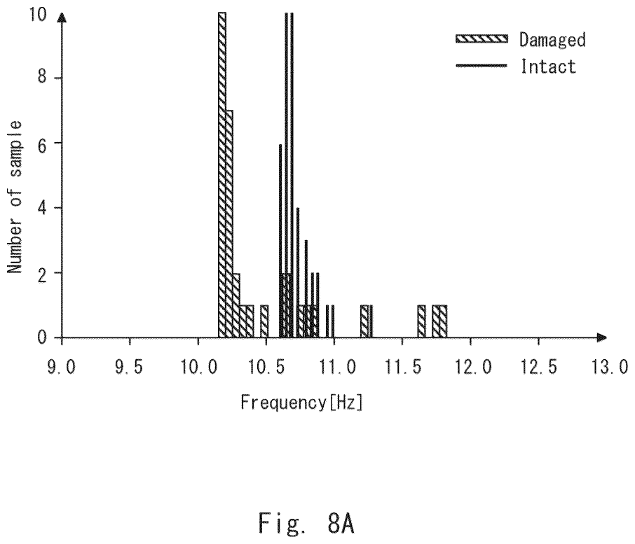

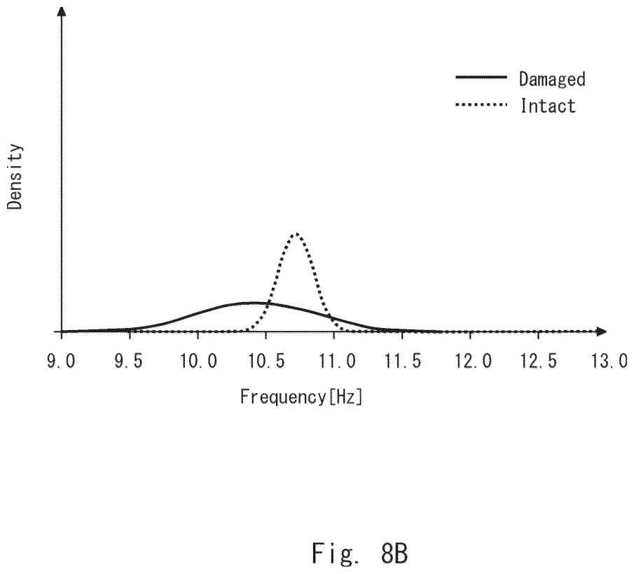

FIG. 8A illustrates one example of the number of events occurring at each frequency at a bridge section as histogram. In FIG. 8A, the horizontal axis indicates frequency in hertz and the vertical axis indicates the number of times vehicle passed over bridge section (the number of sample events). FIG. 8A shows that, when the bridge section becomes damaged from the initial intact state, the frequencies of events vary.

FIG. 8B illustrates one example of the shift of frequency distribution corresponding to FIG. 8A. In FIG. 8B, the horizontal axis indicates frequency in hertz and the vertical axis indicates the density of the frequency density. Also, the statistical distribution of intact and damage condition of bridge frequency is plotted as density distribution. As shown in FIG. 8B, when the bridge section becomes damaged from the initial intact state, the graph of the density distribution is shifted and the standard deviation of the density distribution becomes large. The sensing server 100 may calculate the density distribution shown in FIG. 8B to analyze for estimating the change in structure properties at the bridge section and output the estimation result (if necessary, it can output the result of FIG. 8A and/or 8B.) In this way, the sensing server 100 can be applied as monitoring system to observe the change in the structural properties after correct localization. However, the method of observing the change in the structural properties shown above is only one example and not limited to this.

Modification and adjustment of each example embodiment and each example are possible within the scope of the overall disclosure (including the claims) of the present disclosure and based on the basic technical concept of the present disclosure. The present embodiments are, therefore, to be considered in all respects to be illustrative and not restrictive.

For example, in the second example embodiment, the frequency density estimating unit 106 uses FFT and power spectral densities-based techniques. However, the specific calculation methods used are not limited to these. Other units of the sensing server 100 can use alternative calculation methods other than those mentioned above.

Each disclosure of the above-listed PTL 1 is incorporated herein by reference. Modification and adjustment of each example embodiment and each example are possible within the scope of the overall disclosure (including the claims) of the present disclosure and based on the basic technical concept of the present disclosure. The present embodiments are, therefore, to be considered in all respects to be illustrative and not restrictive.

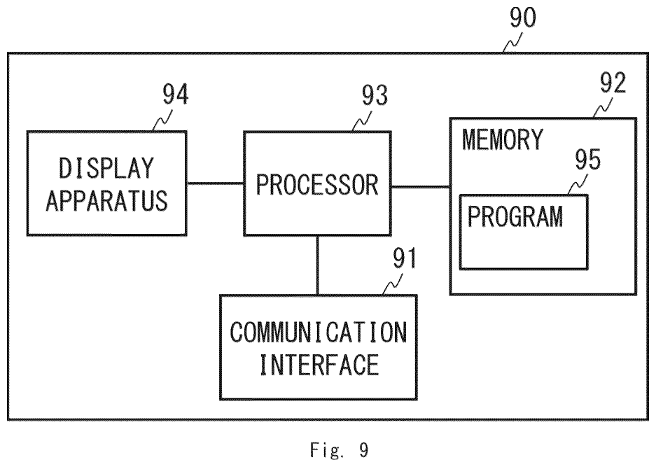

Next, a configuration example of the sensing system (monitoring system) explained in the above-described plurality of embodiments is explained hereinafter with reference to FIG. 9.

The sensing system, which includes both examples of the sensing system 10 and the sensing server 100, may be implemented on a computer system as illustrated in FIG. 9. Referring to FIG. 9, a computer system 90, such as a server or the like, includes a communication interface 91, a memory 92 and a processor 93. Further, the computer system 90 may include also a display apparatus 94.

The communication interface 91 (e.g., a network interface controller (NIC)) may be configured to communicatively connect to sensor(s) provided in an infrastructure. For example, as shown in FIG. 3B, the sensor(s) may be provided under the ground (i.e., a lane of a road). Furthermore, the communication interface 91 may communicate with other computer(s) and/or machine(s) to receive and/or send data related to the computation of the computer system 90.

The memory 92 stores program 95 (program instructions) to enable the computer system 90 to function as the sensing system 10 or the sensing server 100. The memory 92 includes, for example, a semiconductor memory (for example, Random Access Memory (RAM), Read Only Memory (ROM), Electrically Erasable and Programmable ROM (EEPROM), and/or a storage device including at least one of Hard Disk Drive (HDD), SSD (Solid State Drive), Compact Disc (CD), Digital Versatile Disc (DVD) and so forth. From another point of view, the memory 92 is formed by a volatile memory and/or a nonvolatile memory. The memory 92 may include a storage disposed apart from the processor 93. In this case, the processor 93 may access the memory 92 through an I/O interface (not shown).

The processor 93 is configured to read the program 95 (program instructions) from the memory 92 to execute the program 95 (program instructions) to realize the functions and processes of the above-described plurality of embodiments. The processor 93 may be, for example, a microprocessor, an MPU (Micro Processing Unit), or a CPU (Central Processing Unit). Furthermore, the processor 93 may include a plurality of processors. In this case, each of the processors executes one or a plurality of programs including a group of instructions to cause a computer to perform an algorithm explained above with reference to the drawings.

The display apparatus 94 displays the result of the sensing. The display apparatus 94 may be, for example, a liquid crystal display or a touch panel. However, the computer system 90 may include a speaker which informs the result of the sensing in addition to or instead of the display apparatus 94.

The program 95 includes program instructions (program modules) for executing processing of each unit of the sensing system in the above-described plurality of embodiments.

The program includes instructions (or software codes) that, when loaded into a computer, cause the computer to perform one or more of the functions described in the embodiments. The program may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray disc ((R): Registered trademark) or other optical disk storage, magnetic cassettes, magnetic tape, magnetic disk storage or other magnetic storage devices. The program may be transmitted on a transitory computer readable medium or a communication medium. By way of example, and not limitation, transitory computer readable media or communication media can include electrical, optical, acoustical, or other form of propagated signals.

Various combinations and selections of various disclosed elements (including each element in each example, each element in each drawing, and the like) are possible within the scope of the claims of the present disclosure. That is, the present disclosure naturally includes various variations and modifications that could be made by those skilled in the art according to the overall disclosure including the claims and the technical concept.

### REFERENCE SIGNS LIST

10 sensing system
12 dataset processing unit
14 frequency density estimating unit
16 similarity estimating unit
18 localization unit
T wide area localization system
100 sensing server
102 signal acquisition unit
104 raw dataset processing unit
106 frequency density estimating unit
108 similarity estimating unit
110 localization unit
90 computer system
91 communication interface
92 memory
93 processor
94 display apparatus
95 program

What is claimed is:

1. A sensing system comprising:
at least one memory storing instructions; and
at least one processor configured to execute the instructions to:
obtain time-distance information of an oscillation signal for each distributed sensing portion, while the oscillation signal is acquired by the plurality of distributed sensing portions for sensing a monitoring target and is induced by traffic of a moving object;
estimate frequency densities of the oscillation signal sensed by the sensing portions based on the time-distance information;
estimate degree of similarity between pair of the sensing portions based on the frequency densities; and
localize a section of the monitoring target based on the degree of similarity.

2. The sensing system according to claim 1, wherein the at least one processor is further configured to:
generate a time-distance matrix of the oscillation signal as the time-distance information by removing a bias component from the oscillation signal and standardizing an amplitude of the oscillation signal.

3. The sensing system according to claim 2, wherein the at least one processor is further configured to:
estimate the frequency densities of the oscillation signal of the sensing portions by applying Fast Fourier Transformation (FFT) to columns of the time-distance matrix.

4. The sensing system according to claim 1, wherein the at least one processor is further configured to:
calculate a cross-correlation matrix between the frequency densities of the sensing portions to estimate the degree of similarity.

5. The sensing system according to claim 1, wherein the at least one processor is further configured to:
localize the section corresponding to the sensing portions with a similarity index exceeding a given threshold.

6. The sensing system according to claim 1, wherein the at least one processor is further configured to:
use map information to localize real location of the section.

7. The sensing system according to claim 6, wherein the at least one processor is further configured to:
use the real location of the section and the frequency densities of the section to analyze structure properties at the section.

8. The sensing system according to claim 1, further comprising:
an optical fiber cable including the sensing portions and being attached to a road.

9. A sensing method comprising:
obtaining time-distance information of an oscillation signal for each distributed sensing portion, while the oscillation signal is acquired by the plurality of distributed sensing portions for sensing a monitoring target and is induced by traffic of a moving object;
estimating frequency densities of the oscillation signal sensed by sensing portions based on the time-distance information;
estimating degree of similarity between pair of the sensing portions based on the frequency densities; and
localizing a section of the monitoring target based on the degree of similarity.

10. A non-transitory computer readable medium storing a program for causing a computer to execute:
obtaining time-distance information of an oscillation signal for each distributed sensing portion, while the oscillation signal is acquired by the plurality of distributed sensing portions for sensing a monitoring target and is induced by traffic of a moving object;
estimating frequency densities of the oscillation signal sensed by sensing portions based on the time-distance information;
estimating degree of similarity between pair of the sensing portions based on the frequency densities; and
localizing a section of the monitoring target based on the degree of similarity.
